(19) United States
(12) Patent Application Publication
(10) Pub. No.: US 2005/0034805 A1
(43) Pub. Date: Feb. 17, 2005

(54) Belt making apparatus and method

(76) Inventors: Clinton Spangler, Mentor, OH (US); Joseph Kuzmiak, Mentor, OH (US); Kenneth Gladyszewski, Concord Twp, OH (US); Monty Hadi, Mentor, OH (US); Charles Kosa, Madison, NC (US)

Correspondence Address: Watts Hoffamm Co, P O Box 99839, Cleveland, OH, 44199-0839, US

(21) Appl. No.: 10/475,189

(22) PCT Filed: Apr. 18, 2002
(86) PCT No.: PCT/US02/12195

Related U.S. Application Data
(60) Provisional application No. 60/284,724, filed on Apr. 18, 2001.

(51) Int. Cl. F16G 1/00

(52) U.S. Cl. 156/137; 156/138; 156/140; 156/141; 156/494; 156/358; 156/361; 156/378

(57) ABSTRACT

An apparatus and method for making cable reinforced belts or bands and includes cable supply unit for supplying a plurality of reinforcing cables (12), clamping unit for clamping cables under predetermined tension in each of hte reinforcing cables (12). Each tensioning stand (16) includes tensioning units (32) with a tension sensor for monitoring tension in an assocaited cable (12), an actuator (66) for applying a force to the cable (12) to produce therein a predetermined tension and an enclosed feedback controller for the force controlling actuator (66) which controls as a function of the signal generated by a load cell (100) connected to the actuator (66). A cable hold back unit is upstream the tensioning stand (16). Each tensioning unit (32) includes a pair of spaced apart cable sheaves (56) having rotational axes fixed with respect to the respect to the tensioning unit (32).

### TECHNICAL FIELD

The present invention relates generally to laminated bands and belts and in particular to a method and apparatus for making elongated, cable reinforced bands and belts.

### BACKGROUND ART

Cable reinforced belts are used in many applications that require goods, people or other material to be moved from one location to another. These types of belts are generally made using a vulcanizing process in which elastomeric material is bonded to reinforcing cables which may comprise steel wire. There currently exists, machinery for manufacturing these types of belts. In general, these belts are generally formed in successive sections as the belt is intermittently advanced through the processing line. For many applications, the belt must be of very high quality so that it has a very long service life. In general, the manufacture and replacement of these types of conveyor belts can be very costly.

It has been found that premature failure of these types of belts can arise due to relative movement of the reinforcing cables within the vulcanized material. The failure producing movement in the reinforcing cables can sometimes be traced to the manufacturing process. In particular, if the tension in the reinforcing cables is not carefully controlled during the belt making process, premature failure in the belt due to movement in the reinforcing cables relative to the belt material, can occur.

There currently exists equipment for tensioning the reinforcing cables during the belt manufacturing process. An example of prior art cable tensioning apparatus is illustrated in U.S. Pat. No. 3,502,535.

It has been found however there exists a need for an apparatus capable of producing higher quality belts and bands than can be produced with existing equipment.

### DISCLOSURE OF THE INVENTION

The present invention provides a new and improved method and apparatus for making cable reinforced flexible belts or bands. More specifically, the present invention provides a new and improved method and apparatus for controlling the tension in, and movement of reinforcing cables forming part of an elongate, flexible cable reinforced band or belt.

According to the invention, the apparatus includes a cable supply station for supplying a plurality of reinforcing cables which ultimately form part of the finished belt. A clamping unit located downstream of the cable supply station is used to clamp the cables under predetermined operating conditions. At least one tensioning stand is used to apply and control tension in each of the cables during the belt making process. A cable hold back device is also disclosed for controlling tension in the cables during an advancing step.

In the preferred embodiment, the tensioning stand includes a plurality of tensioning units, each unit being operative to apply and maintain tension in an associated cable. In the preferred and illustrated embodiment, each tensioning unit includes a tension sensing device for monitoring tension in the associated cable. An actuator under the control of a controller exerts a force on the cable in order to produce a desired tension in the cable. The tension sensor in cooperation with the controller controls the actuator in order to generate and maintain the desired tension.

In the illustrated embodiment, the tension sensor is a load cell operatively connected to the actuator. The actuator itself is preferably a fluid pressure operated actuator that controls the position of a sheave around which the associate cable is wound. The controller is responsive to a signal generated by the load cell and uses the signal to control a proportional valve which is operative to maintain a predetermined pressure in the fluid pressure operated actuator in order to generate and maintain a predetermined tensioning force in the associated cable. In the exemplary embodiment, each tensioning unit includes a pair of spaced apart rotatable sheaves which are disposed on either side of the moveable sheave to which the actuator is attached. In the preferred and illustrated embodiment, the cable is reeved over an upstream fixed sheave, under the moveable sheave and over the fixed, downstream sheave. Relative movement between the actuator mounted sheave and the fixed sheaves produces tension in the associated cable.

According to a feature of the invention, the actuator may be operated to move the moveable sheave to a loading position which enables the associated cable to be threaded between the fixed and moveable sheaves.

According to the invention, the cable hold back device includes a driven roller having an axis of rotation extending transverse to the direction of travel of the reinforcing cables and an idler roller having an axis parallel to the axis of rotation of the driven roll and moveable towards and away from the driven roll. The cable hold back unit is operative to control tension in the cables as they are advanced and to apply pretensioned forces to the cables prior to clamping by the clamping unit.

According to another feature in the invention, the actuators in the tension stand are fed by common fluid supply manifolds. One manifold feeds fluid to the proportional valve forming part of each tensioning unit. In the preferred embodiment, the proportional valve controls the application of fluid pressure to a rod end of its associated actuator. In the preferred embodiment, another fluid manifold forming part of the tension stand feeds fluid pressure to a cylinder end of each actuator and is pressurized to extend the actuators in order to move their associated sheaves to a cable loading position.

With the present invention, the tension in each reinforcing cable can be precisely controlled and maintained while the cables are stationary i.e. during a vulcanizing step as well as during an advancing step.

Additional features of the invention will become apparent and a fuller understanding obtained by reading the following detailed description made in connection with the accompanying drawings.

### BRIEF DESCRIPTION OF THE DRAWINGS

FIG. 1 is a side elevational view, shown somewhat schematically, of an apparatus for making reinforced belts or bands such as conveyor belts;

FIG. 2 is a side elevational view of a portion of the apparatus shown in FIG. 1, showing a hold back device and tensioning devices, constructed in accordance with the preferred embodiment of the invention;

FIG. 3 is a side view of one of the tensioning devices shown in FIG. 2 as seen from the plane indicated by the line 3-3 in FIG. 2;

FIG. 4 is a side elevational view of a tensioning unit forming part of the tensioning device as seen from the plane indicated by the line 4-4 in FIG. 3;

FIG. 5 is a fragmentary view of the tensioning unit shown in FIG. 4 as seen from the plane indicated by the line 5-5 in FIG. 3;

FIG. 6 is a fragmentary view of a portion of the tensioning device, indicated by the circle marked “FIG. 6” in FIG. 3;

FIG. 7 is a side view of a cable hold back device constructed in accordance with the preferred embodiment of the invention;

FIG. 8 is a schematic representation of a control arrangement for controlling an actuator forming part of the tensioning unit shown in FIG. 4; and,

FIG. 9 is a flow chart illustrating the modes of operation and functions that are controlled by a controller during the making of a belt.

### BEST MODE FOR CARRYING OUT THE INVENTION

FIG. 1 schematically illustrates an apparatus for making reinforced, flexible belts or bands such as the type used in conveyor systems. Generally, the reinforcement for the belt comprises a plurality of cables or strands which may be made from steel or other suitable material. For purposes of an explanation, the apparatus will be described in connection with the making of steel reinforced conveyor belts. However, it should be understood that the invention disclosed may be used with other types of laminated band or belt materials that are reinforced with other types of cables or strands.

In the type of apparatus and method for making belts, to which this invention pertains, the belt is constructed in successive sections. In other words, the belt being manufactured does not move continuously. The processing line is stopped while a section of belt is being formed and at the conclusion of the forming cycle, the line is incrementally advanced.

In general, the apparatus for making belts, shown in FIG. 1, includes a cable supply station 10 which supports spools or reels of reinforcing cables to which the belt material is ultimately laminated or vulcanized to. A plurality of reinforcing cables are fed from the supply station, the number and size of the cables being determined by the desired belt construction or belt “recipe”. The wires form the core of the finished belt. In the illustrated arrangement, the cables lie in a common horizontal plane and are guided into a parallel arrangement. The reference character 12 is intended to refer to the array of cables and the plane that they travel along.

The belt making apparatus includes a clamping unit 14 which clamps the cables 12 in place when a section of belt is being formed. The clamping unit 14 is considered conventional and operates to inhibit movement in the cables 12 and so that a tension can be applied to the cables 12 and maintained by one or more tensioning devices or stands indicated generally by the reference character 16. The processing line generally includes a compacting press 20 which applies belt material to a segment of the reinforcing or core cables. As seen in FIG. 1, the cables 12 travel through the press 20. Downstream of the compacting press 20 is a heated platen press 24 which heat treats, bonds or vulcanizes the belt material applied to the cables by the compacting press 20 to form the finished, integrally molded belt segment. The finished belt segment is ultimately delivered to a take up reel or other take up mechanism (not shown).

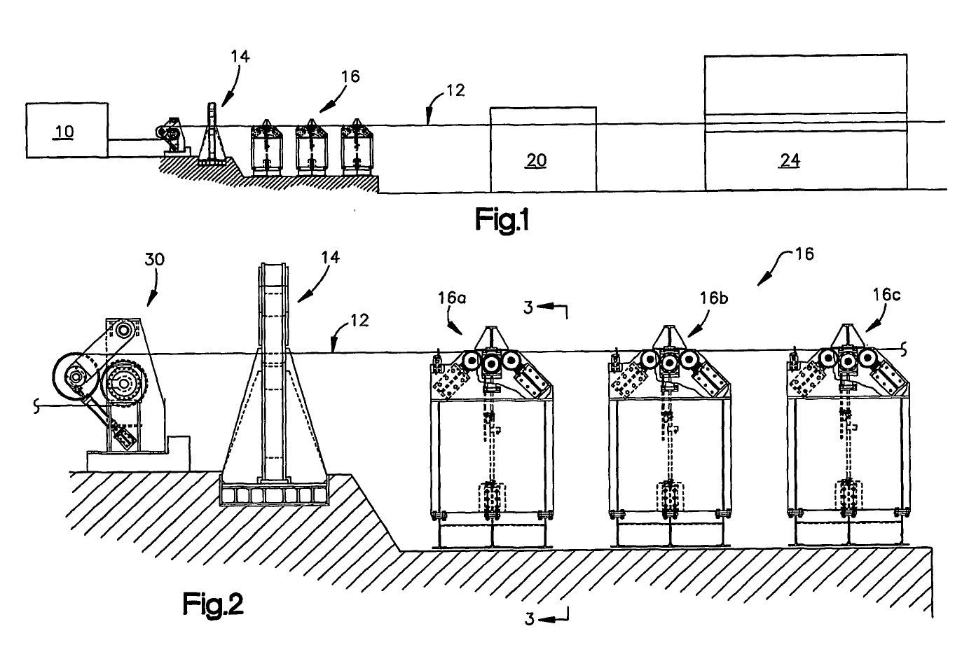

Referring also to FIG. 2, in the illustrated embodiment, the belt making apparatus includes a cable hold back assembly 30 constructed in accordance with the preferred embodiment of the invention and three individual cable tensioning stands 16a, 16b and 16c. All three stands are essentially identical and as a consequence only one of the stands will be described. Multiple stands are required because it is difficult, due to the close spacing of the cables, to utilize a single stand to apply tension to all cables. With the disclosed arrangement, one-third of the cables are tensioned by each stand. As an example, if 99 reinforcing cables are used in the belt, 33 of the cables will be tensioned by the stand 16a. Thirty-three other cables will be tensioned by the stand 16b and the remaining 33 cables will be tensioned by the stand 16c. In the example, the first, fourth, seventh and 97^{th} strand would be tensioned by the first strand. The second, fifth, eighth and 98^{th} strand would be tensioned by the second strand. The third, sixth, ninth and 99^{th} strand would be tensioned by the third strand.

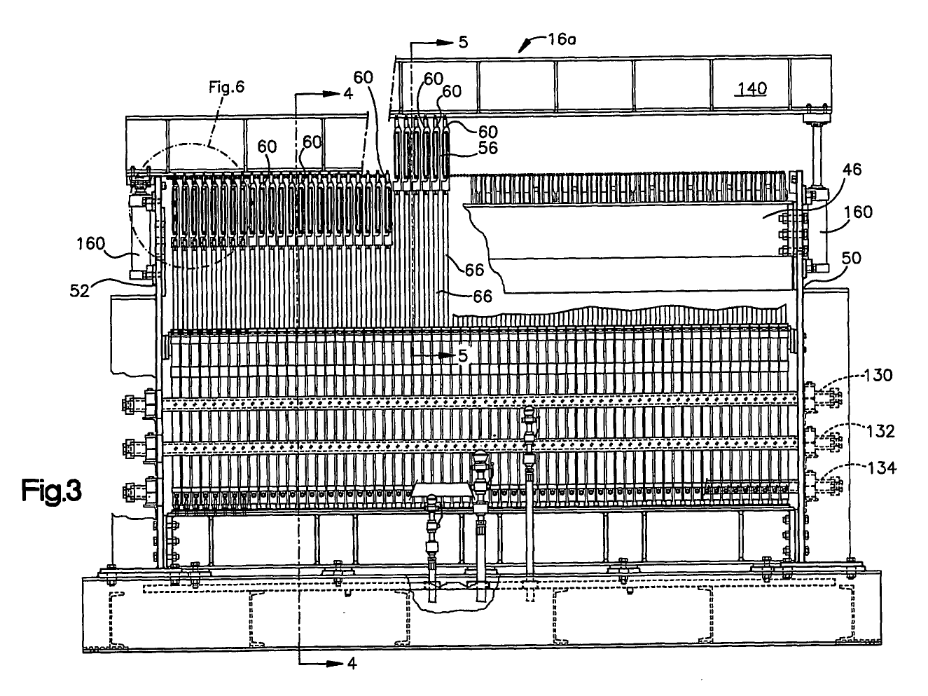

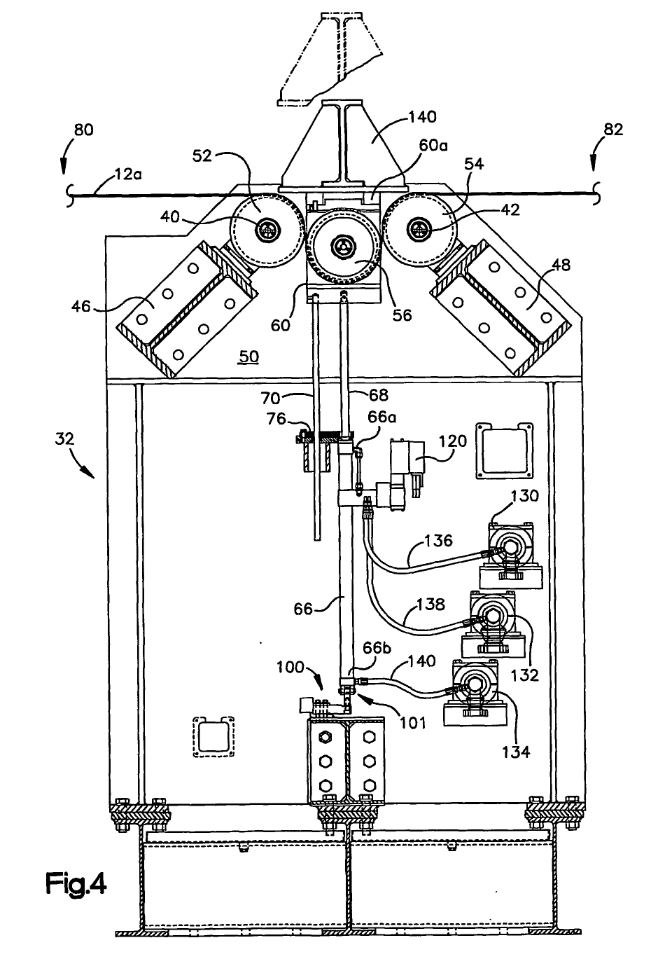

Referring to FIGS. 2 and 4, each tensioning stand 16a, 16b, 16c comprises a plurality of tension units or stations 32, each station 32 applying tension to one of the cables 12. FIG. 4 illustrates the overall construction of a cable tensioning station 32. Referring also to FIG. 5, the tensioning station includes a pair of aligned, fixed pulleys or sheaves 52, 54 that are positioned on either side of a movable pulley or sheave 56. As indicated above, each tensioning stand 16a, 16b, 16c includes a plurality of tensioning stations 32, one of which is illustrated in FIG. 4. In the preferred embodiment, the fixed sheaves 52, 54 form part of an assembly which includes a plurality of sheaves carried on respective common shafts 40, 42 and which are supported by respective cross beams 46, 48. The support beams 46, 48 extend between spaced apart frame members 50, 52 shown best in FIG. 3.

Referring again to FIGS. 4 and 5, the moveable sheave 56 is rotatably carried by a holder 60. The holder 60 is reciprocally moveable in the vertical direction by an actuator 66 which includes a reciprocally moveable rod 68. The upper end of the rod 68 is connected to the holder 60 so that movement in the rod 68 produces vertical movement in the holder 60. A guide rod 70 extends downwardly from the holder 60 and extends through a guide 76, fixed with respect to the frame of the stand 16a, and inhibits rotation in the holder 60 about the axis defined by the rod 68 thereby maintaining alignment of the sheave 56 with the sheaves 52, 54. The guide 76 does not vertically constrain the body of the actuator 66.

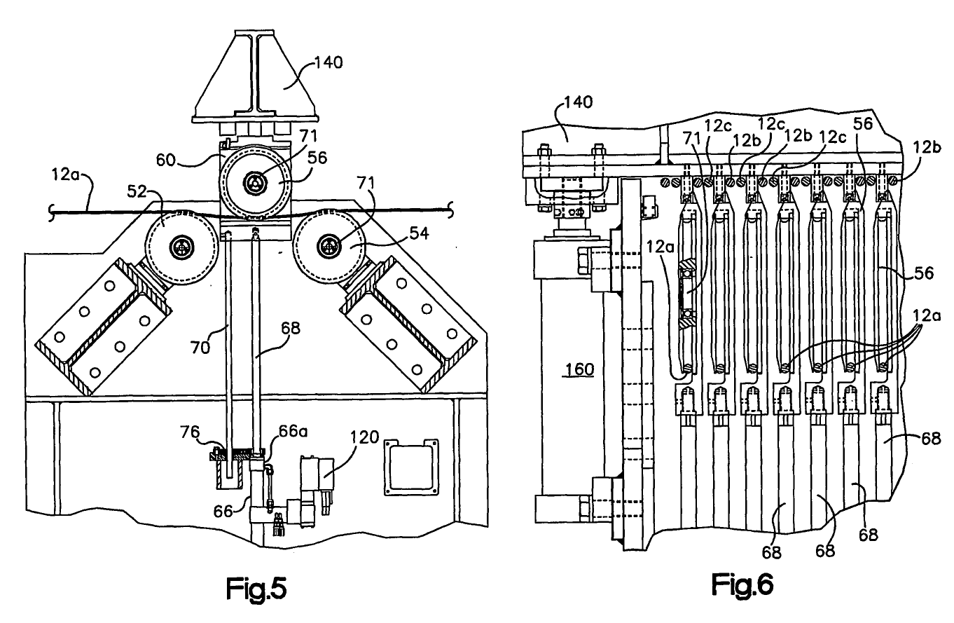

Referring to FIGS. 5 and 6, the fixed sheaves 52, 54 and the movable sheave 56 are mounted with ball bearings 71 that have integral seals on both sides. The integral seals on the sides of the bearings exclude contamination from the bearing to prevent premature failure of the bearings due to contamination.

During a belt making operation, a cable 12a is positioned over the upstream, fixed sheave 52, under the moveable sheave 56 and over the downstream, fixed sheave 54. If the downstream and upstream ends of the cable 12a, indicated generally by the reference characters 80, 82, respectively are held by a suitable clamping mechanism, downward movement of the moveable sheave 56 will apply a tension force to the cable 12a Downward movement of the sheave 56 is effected by the actuator 66. In the illustrated embodiment, the actuator 66 is hydraulic. Fluid pressure applied to a rod end 66a of the actuator 66 applies a retraction force to the rod 68 thereby generating a tension force in the cable 12a, the amount of the tension being a function of the fluid pressure level applied to the rod end 66a of the cylinder 66.

According to the invention, the tension force is monitored by a load cell 100 which is attached to the bottom of the actuator 66 (see FIG. 4). The illustrated connection between the load cell and the bottom of the actuator is a pin connection 101. In the exemplary embodiment, the only vertical constraint on the bottom of the actuator is the pin connection to the load cell. One acceptable load cell that may be used is a shear beam cell model no. 3290, produced by Lebow. It should be apparent that as the holder 60 is pulled downwardly by the retraction of the rod 68, the actuator tries to move upwardly in reaction to the force thus applying an upward, pulling force to the load cell 100 which in turn is converted to an electrical signal that can be monitored by a controller. The controller in turn can be used to control the fluid pressure applied to the rod end 66a of the actuator 66 and hence the tension applied to the cable 12a. In particular, the pressure in the rod end 66a of the actuator 66 is controlled by a pressure control valve 120 which is operable to maintain a pressure in the rod end 66a of the actuator 66 in response to a reference voltage communicated to the proportional valve 120 by the controller. By using the proportional valve in combination with the load cell 100, a closed loop feedback arrangement is provided so that a very precise tension force can be applied to each individual cable 12a. Acceptable pressure control valves are Bosch pressure control valves with onboard electronics. One acceptable pressure control valve is Bosch model no. NG6, part number 0-811-402-080.

As seen best in FIG. 4, each tension station is connected to a high pressure manifold 130, a return manifold 132 and a low pressure manifold 134 by respective supply conduits 136, 138, 140. As described above, a desired pressure level in the rod end 66a of the cylinder 66 is maintained by the proportional valve 120 in response to signals provided to it by the controller. The low pressure manifold 134 supplies fluid pressure to the cylinder end 66b in order to extend the rod 68 under predetermined operating conditions. In the preferred embodiment, however, when the cable 12a is being precisely tensioned, the fluid pressure to the low pressure manifold is reduced so that the cylinder end 66b of the actuator 66 is slightly pressurized. Alternately, the pressure may be terminated.

FIG. 5 illustrates a cable threading feature of the invention which facilitates the initial set up of the machine. During production of a conveyor belt, the moveable sheave 56 is normally located at or below the position shown in FIG. 4. In other words, the axis of the moveable pulley is normally below the axes of the fixed pulleys 52, 54. A moveable beam 140 forms an abutment for the holder 60 preventing the holder from moving too far upwardly. During initial threading of the machine however, the threading of the cable 12a is greatly facilitated if the moveable sheave 56 can be positioned at a level higher than the fixed pulleys 52, 54, as shown in FIG. 5. To enable this upward movement as part of a threading operation, the abutment beam 140 is raised upwardly by a pair of actuators 160 mounted to the side plates 50, 52 (see FIG. 3). The cylinder end 66b of the actuator 66 is pressurized in order to move the holder 60 and hence the sheave 56 upwardly to the position shown in FIG. 5. After threading is completed, the rod end 66a of the actuator 66 is pressurized in order to pull the holder 60 downwardly to the position shown in FIG. 4, or a lower position (depending on how much slack is in the cable 12a). The abutment beam 140 is then lowered by retracting the actuators 160.

As indicated above, each tension stand tensions up to one-third of the total number of cables forming part of the reinforced belt. As seen in FIG. 6, cables indicated by the reference character 12a are being tensioned by respective actuators 66. Cables indicated generally by the reference character 12b pass through the tension stand 16a and are in turn tensioned by tension stations located in the tension stand 16b. The remaining cables indicated generally by the reference character 12c pass through both tension stands 16a and 16b and are tensioned by tensioning stations located in the tension stand 16c.

Unlike prior art tensioning devices, the tension stand of the present invention includes a plurality of tensioning stations 32, each of which can apply a controlled tension to an associated cable 12a Each station 32 includes its own proportional valve for controlling its associated actuator 66. The controller monitors the tension being applied to the associated cable by means of the associated load cell 100 and can make constant set point changes to the proportional valve 120 in order to maintain a precise tension in the cable 12a With the disclosed apparatus, very precise tension forces can be applied and maintained in each of the cables that form the conveyor belt thus producing a higher quality belt.

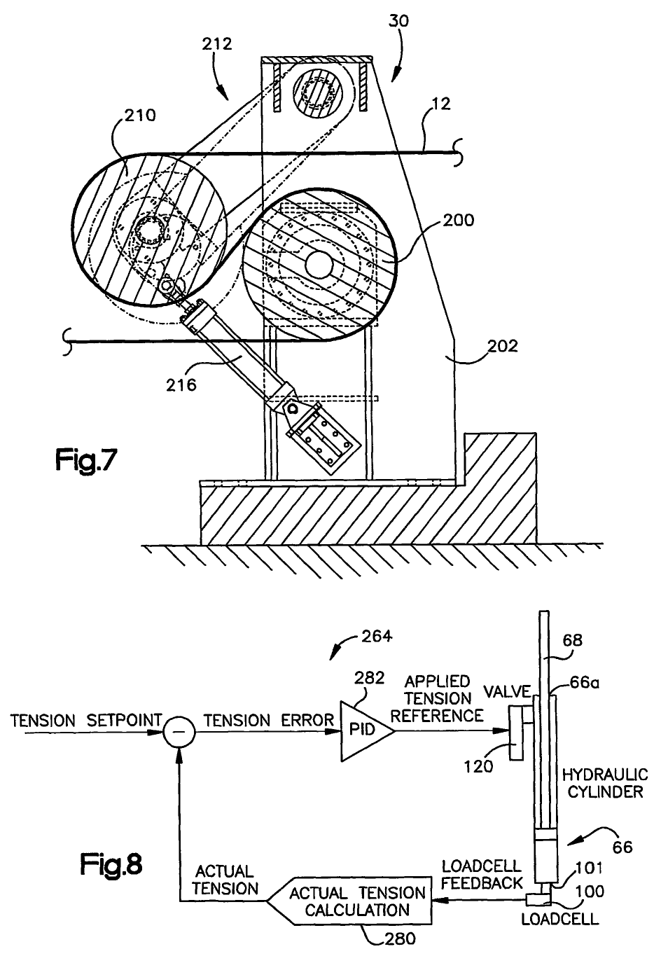

Turning now to FIG. 7, a cable hold back unit 30, constructed in accordance with the preferred embodiment of the invention is illustrated. The illustrated cable hold back unit 30 is used to control tension in the cables 12 when the cables 12 are being advanced after the completion of a belt section. The hold back unit 30 includes a driven roll 200 supported between a pair of end plates 202 (only one is shown). In the preferred embodiment, the driven roll 200 is coupled to a reversible motor, preferably a hydraulic motor (not shown). An idler roll 210 supported between a swingable frame 212 that is moveable towards and away from the driven roll 200 by a pair of actuators 216 (only one is shown) mounted to the end plates 202. As seen in FIG. 7, the cables 12 are positioned around the driven and idler rolls 200, 210 in an S shaped pattern. When the idler roll 210 is moved towards the driven roll 200 to the position shown in phantom, the cables 12 are essentially clamped between the rolls. As indicated above, when a section of belt is completed, the belt is advanced to position another segment of the belt in the platen press. The hold back unit 30 is used to maintained some tension in the cables 12 during this advancement step to prevent the cables 12 from going excessively slack.

In order to thread the cables 12 through the hold back unit 30 at initial startup, the idler roll 210 is moved away from the driven roll 200 by the actuators 216 in order to provide clearance. After the threading is complete, the idler roll 210 is normally moved towards the driven roll 200 and may be pivotally moved into abutting engagement with the driven roller in order to directly clamp the cables between the rollers. In some applications, a clearance between the rollers may be maintained.

During belt advancement, the hydraulic motor attached to the driven roll 200 is fed pressurized fluid in order to resist uncontrolled rotation in the roll 200 in response to pulling forces applied to the cables 12. The hydraulic motor in effect produces a controlled drag on the driven roll 200 so that the reinforcing cables 12 are maintained under some tension as they are being advanced. In the preferred embodiment, the cables 12 are clamped by a conventional clamping unit 14 (shown in FIG. 1) at the conclusion of the advancing step and then re-tensioned by the tensioning stands 16a, 16b and 16c.

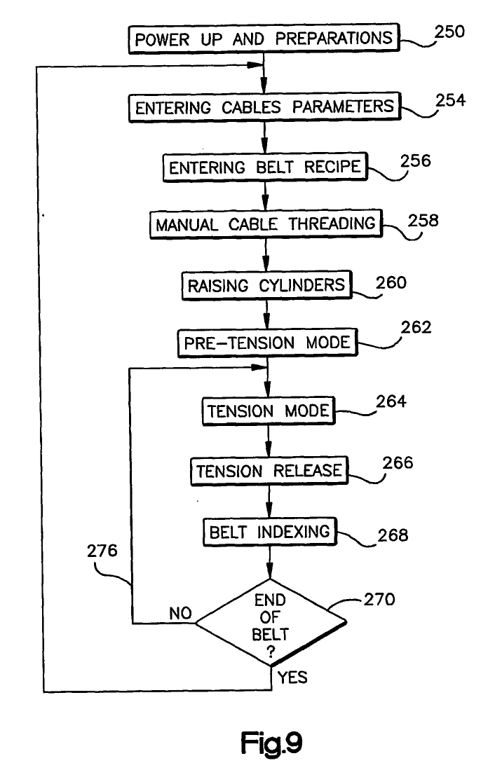

The overall operation and function of the tension stands 16a, 16b, 16c and, in particular, the individual tension units 32, are controlled by a suitable controller. The disclosed tensioning stands 16a, 16b, 16c may be controlled by a Controllogix 5000 programmable logic controller (PLC) which is available from Allen Bradley. The PLC is used to control the various fluid pressure valves, load cells and other operator devices, such as push buttons and lights. The flow chart shown in FIG. 9 illustrates the modes of operation, as well as the functions that are performed by or under the control of the controller and/or by operators in order to control the tension in the cables 12a during the making of a belt. The first block 250 represents the power-up and other initial preparations that need to be made in order to begin system operation. These preparations include the start-up of the hydraulic unit which provides the hydraulic pressure to the manifolds 130, 134 (see FIG. 4).

In order for the system to accurately calculate and apply the tension in each cable, a set of mathematical linear equations is used. These equations are derived outside the system for each different cable diameter and mass. The equation's slope and offset are then entered into the system and is preferably stored for future use and reference. This action is represented by the block 254 (see FIG. 9). Following the entry of cable parameters, a “belt recipe” must be entered as represented by the block 256. The recipe information entered into the system may include the following data: order no., cable count, cable diameter, minimum and maximum tension, and tension applied.

Following the entry of the “belt recipe,” the cables must be threaded through the tensioning stands 16a, 16b, 16c. In the preferred embodiment, the stop beam 140 is first raised to its upper position which is shown in phantom in FIG. 4 and is solid in FIG. 5. However, the movable sheaves 56 are maintained in their lower position (shown in FIG. 4). With the stop beam 140 raised, the cables can be fed through each station along the tops of the fixed sheaves 52, 54 as represented by the block 258.

After all of the cables are threaded through the tension stands 16a, 16b, 16c, the control system is activated to extend the rods 68 of each of the actuators 66 (represented by the block 260). Each holder 60 includes a sharp leading or top edge 60a (see FIG. 4). Referring to FIG. 5, as the holder 60 and its associated sheave 56 move upwardly, the sharp upper edge 60a guides or moves the cable 12a towards the outside of the sheave 56 allowing the sheave to move past the cable as it moves upwardly. Once the bottom of the sheave 56 moves above the cable (see FIG. 5) the cable will move under the sheave 56, either automatically or with the help of an operator. The engagement of the cable with the tops of the fixed pulleys 52, 54 and the bottom of the movable pulley 56, as a result of this threading operation, is shown in FIG. 5.

With the cable 12a under the sheave 56, the pretension function can be activated as represented by the block 262. In the pretension mode, the rod end 66a of the actuator 66 are pressurized under the control of the proportional valve 120 to cause the rod 68 to retract thereby pulling the holder 60 and associated sheave 56 downwardly. The holder will move downwardly until the hydraulic force is balanced by the tension generated in the cable. Occasionally, a cable may slip from the sheave 56 and, as a result, the actuator 66 will “bottom out” (in other words the rod 66 will fully retract). This is monitored by the control system and if “bottoming” is detected, those actuators 66 are extended to raise the holder 60 so that the associated cables can be engaged.

Once all of the cables are engaged and pretensioned, in all three tensioning stands 16a, 16b, 16c can then be switched to tension mode (represented by block 264). In tension mode it is preferred that the stop beam 140 be lowered to the position shown in FIG. 4. In tension mode, as represented by the block 264, a residual fluid pressure is maintained in the cylinder or piston end 66b of each actuator 66. In some applications the fluid pressure at the piston end 66b may be terminated. The controller then begins sending reference signals to the proportional valves 120 of each actuator 66 in order to retract the rod 68 thus causing the sheave 56 to apply tension in its associated cable 12a. The tension applied to the cable 12a is monitored by the load cell 100, one of which is attached to each actuator 66. The reference signals sent to the proportional valves 120 are adjusted by the controller in response to the associated load cell readings until a desired tension is achieved in the cable 12a being acted upon by the particular tension unit 32. In other words, the tension in each cable 12a is monitored by the controller, via the load cell and pressure adjustments are made to the associated actuator by means of signals sent to the associated proportional valve 120 so that a desired tension is maintained in each individual cable. With the disclosed system, the tension in each cable is individually controlled based on a closed loop feed back system and is done independently of all other cables.

FIG. 8 schematically illustrates the method by which tension is applied to a cable 12a by an actuator 66, as represented by the tension mode block 264 in FIG. 9. Referring to FIG. 8, the controller generates a tension set point, based on data entered for the belt being manufactured. The load cell 100 which monitors the load on the associated cable 12a generates a signal related to the load. This signal is used to calculate the actual tension in the cable as represented by block 280 in FIG. 9. This tension data is compared with the tension set point and, if different, generates an error signal which is conveyed to a proportional integral derivative control 282 which generates a reference signal for the proportional valve 120. The proportional valve 120, in turn, adjusts the fluid pressure applied to the rod end 66a of the actuator 66 in order to increase or decrease the force applied to the cable in order to produce the desired tension. The illustrated closed loop feedback control enables a precise tension force to be applied and maintained to an associated cable 12a.

As is conventional, during the tension mode, the compacting presses and platen presses 20, 24 are either applying belt material or bonding belt material to the segment of cables passing through the respective presses. As indicated above, the belt is processed in segments. Following the completion of a belt segment, the control system must perform a tension release to enable the belt to be indexed. In the illustrated apparatus, during tension release (as represented by the block 266) tension in each cable is reduced to approximately 15 lbs., using the same methodology shown in FIG. 8 and described above. At this tension, the overall belt (and cables 12) can be indexed (represented by block 268). Forward movement of the cables 12 is also controlled by the holdback unit 30 described above. Following indexing of the belt, the control sequence returns to the tension mode as represented by the return line 276, unless the end of the belt has been reached (block 270). If the end of the belt has been reached, the system returns to the control block 254, where the parameters of the cables is to be used on the next belt are entered.

Although the invention has been described with a certain degree of particularity it should be understood that those skilled in the art can make various changes to it without departing from the spirit or scope of the invention.

1. Apparatus for making cable reinforced belts, comprising:
a) a cable supply unit for supplying a plurality of reinforcing cables;
b) a clamping unit for clamping said reinforcing cables under predetermined operating conditions;
c) at least one cable tensioning stand for maintaining a predetermined tension in each of said cables, said tensioning stand comprising a plurality of tensioning units, each tensioning unit including;
i) a tension sensor for monitoring tension in an associated cable;
ii) an actuator for applying a force to the associated cable in order to produce a predetermined tension in said cable;
iii) an actuator controller for controlling the force applied by said actuator as a function of signal generated by said tension sensor.

2. The apparatus of claim 1, wherein said tension sensor is a load cell operatively connected to said actuator.

3. The apparatus of claim 2, wherein said controller includes a proportional valve for maintaining a predetermined fluid pressure in said actuator such that said actuator is controlled to produce a substantially constant tension in said associated cable.

4. The apparatus of claim 1 further including a cable hold back unit, located upstream of said tensioning stand which is operative to control tension in said reinforcing cables during advancement of said cables.

5. The apparatus of the claim 4, wherein said cable hold back unit includes a driven roll extending transversely to a direction of movement of said reinforcing cables and an idler roll extending parallel to said driven roll and in a confronting relationship therewith, said idler roll moveable towards and away from said driven roll.

6. The apparatus of claim 1 wherein said tensioning unit includes a pair of spaced apart cable sheaves having rotational axes fixed with respect to said tensioning unit and a moveable sheave operatively coupled to said actuator and moveable with respect to said fixed sheaves.

7. A method for making a cable reinforced belt, comprising the steps of:
a) providing a plurality of reinforcing cables to form part of said belt;
b) maintaining a predetermined tension on each of said cables by:
i) applying a force to each cable by means of an associated fluid pressure operated actuator;
ii) monitoring a load on said actuator as a result of applying forces to said associated cable;
iii) generating a signal that is a function of the load on said actuator;
iv) using said signal to calculate an actual tension in said associated cable;
v) comparing said calculated tension with a tension data set point;
vi) generating an error signal, if said tension data set point and calculated tension are not equal; and,
vii) using said error signal to generate a signal for a proportional valve that is operative to control fluid pressure applied to said actuator in order to adjust the force applied to said associated cable until a desired tension is obtained.

8. The method of claim 7, further including the step of utilizing a cable hold back unit having a driven roll and an idler roll and adjusting a spacing between said rolls in order to control tension in said cables during an advancing step.

9. The method of claim 7, further including the step of providing a pair of spaced apart sheaves that are fixed with respect to said actuator and providing a movable sheave operatively connected to said actuator such that relative movement between said fixed sheaves and said movable sheave applies forces to said associated cable.

10. A cable tensioning stand for use in a cable reinforced belt making apparatus, comprising:
a) a frame;
b) a plurality of tensioning units mounted within said frame;
c) each tensioning unit including:
i) an actuator operatively connected to a moveable sheave;
ii) a pair of spaced apart sheaves located on either side of a path of movement for said movable sheave;
iii) a load cell for monitoring a force exerted by said actuator on an associated cable;
iv) a controller responsive to signals produced by said load cell and operative to compare said monitored force with a desired force; and,
v) said controller generating a signal for a proportional valve that is a function of the difference between said monitored force and said desired force;
vi) said proportional valve responsive to said generated signal and operative to control fluid pressure applied to said actuator in order to control the force applied by said actuator to its associated cable.

11. The tension stand of claim 10, including a manifold for feeding pressurized fluid to all of said actuators in order to move said movable sheave to a cable loading position.
